(19) United States
(12) Patent Application Publication
(10) Pub. No.: US 2006/0212181 A1
(43) Pub. Date: Sep. 21, 2006

(54) Method and apparatus for extending useful range of air data parameter calculation in flush air data systems

(75) Inventors: Dennis James Cronin, Shakopee, MN (US); Travis Jon Schauer, Shakopee, MN (US)

Correspondence Address: GOODRICH C/O WESTMAN, CHAMPLIN & KELLY, P.A., SUITE 1400, 900 SECOND AVENUE SOUTH, MINNEAPOLIS, MN, 55402-3319, US

(73) Assignee: Rosemount Aerospace Inc., Burnsville, MN (US)

(21) Appl. No.: 11/082,359

(22) Filed: Mar. 16, 2005

(51) Int. Cl. G01C 23/00

(52) U.S. Cl. 701/3; 701/4

(57) ABSTRACT

A method of calculating a system level air data parameter for an aircraft using a flush air data system includes measuring local static pressures using the pressure sensing ports. Next, impact pressure effecting conditions are determined. Based on the determined impact pressure effecting conditions, one of multiple different algorithms is selected for generating an impact pressure dependent parameter. The impact pressure dependent parameter is then generated using the selected algorithm. Finally, the system level air data parameter is calculated as a function of the generated impact pressure dependent parameter. A flush air data system includes the flush static pressure sensing ports and an air data computer configured to implement the steps of the method.

### FIELD OF THE INVENTION

The present invention relates generally to Flush Air Data Systems (FADS) used on aircraft. More particularly, the present invention relates to methods and apparatus for extending useful air data parameter signal ranges in FADS.

### BACKGROUND OF THE INVENTION

Flush Air Data Systems (FADS) are increasingly being used or proposed on aircraft or air vehicles (manned or unmanned). A FADS typically utilizes several flush or semi-flush static pressure ports on the exterior of an aircraft to measure local static pressures at various positions. The pressure or pressure values measured by the individual ports are combined using some form of algorithm(s) into system (global or aircraft level) air data parameters for the aircraft. Examples of these system air data parameters for the air vehicle include angle of attack (AOA), angle of sideslip (AOS), Mach number, etc. Other well known system air data parameters for the aircraft can also be derived from estimates of static and total pressure and their rates of change.

By way of example, a traditional FADS typically includes approximately five pressure sensing ports positioned on the aircraft, though other numbers of ports can be used instead. Ideally, one of the pressure sensing ports is in a position to measure total pressure Pₜ in that it is on a surface perpendicular to the airflow. Examples of such positions include at the nose or leading edge of a wing of the aircraft. The other four ports are used in various combinations to provide a system AOA, AOS and/or static pressure Pₛ signal (in conjunction with the Pₜ signal) which characterizes the corresponding air data parameter. A wide variety of algorithms can be used provide these air data parameters. For example, algorithms used in conventional five hole spherical head air data sensing probes can be used. The pressures or pressure values can also be combined using some form of artificial intelligence algorithms, e.g., neural networks (NNs), support vector machines (SVMs), etc.

Flush air data systems provide numerous advantages which make their use desirable for certain aircraft or in certain environments. For example, the flush or semi-flush static pressure ports can result in less drag on the aircraft than some other types of pressure sensing devices. Additionally, the flush or semi-flush static pressure sensing ports experience less ice build-up than some other types of pressure sensing devices thus requiring less power for de/anti-icing. Other advantages of a FADS can include, for example, lower observability than some probe-style air data systems.

However, one problem with FADS is that a usable total pressure Pₜ signal is hard to obtain. This is due to the fact that, as an aircraft changes attitude, a port that may have sensed a pressure close to total pressure Pₜ (due to its being on a surface perpendicular to the oncoming flow) is no longer is the same orientation. This leads to the pressure sensed being reduced. In some cases, the pressure sensed by the total pressure port can be even lower than the system static pressure Pₛ measured or generated using some or all of the other four ports.

The difference between total pressure and static pressure, which is often referred to as the impact pressure, can therefore change from a nominally positive value to a negative value. Measured impact pressure is commonly denoted here as q_{cm}. For purpose of non-dimensionalizing the measured pressures, impact pressure is typically used in the denominator of air data calculations. Therefore, when the impact pressure becomes very small, the non-dimensionalized value can blow up (become extremely large), or even become undefined, making the air data parameter calculation unreliable.

Embodiments of the present invention provide solutions to these and/or other problems, and offer other advantages over the prior art.

### SUMMARY OF THE INVENTION

A method of calculating a system level air data parameter for an aircraft using a flush air data system includes measuring local static pressures using the pressure sensing ports. Next, impact pressure effecting conditions are determined. Based on the determined impact pressure effecting conditions, one of multiple different algorithms is selected for generating an impact pressure dependent parameter. The impact pressure dependent parameter is then generated using the selected algorithm. Finally, the system level air data parameter is calculated as a function of the generated impact pressure dependent parameter.

Other features and benefits that characterize embodiments of the present invention will be apparent upon reading the following detailed description and review of the associated drawings.

### BRIEF DESCRIPTION OF THE DRAWINGS

FIGS. 1-1 and 1-2 are diagrammatic illustrations of flush air data pressure sensing ports on an air vehicle as seen from top and bottom views, respectively, in an example embodiment.

FIG. 2 is a plot of angle of sideslip (AOS) signals generated at constant aircraft angles of attack (AOA's) using a single predetermined static pressure sensing port to provide a total pressure measurement.

FIG. 3 is a plot of angle of sideslip (AOS) signals generated at constant aircraft angles of attack (AOA's) using maximum and minimum static pressures to provide a measured impact pressure and a estimation of the system level static pressure measurement.

FIG. 4 is a flow diagram illustrating a method in accordance with the present invention.

FIG. 5 is a plot illustrating an AOA signal at various aircraft AOA's.

FIG. 6 is a plot illustrating an impact pressure dependent parameter, and its inverse, used in accordance with some embodiments of the present invention.

FIG. 7 is a diagrammatic illustration of a flush air data system in accordance with embodiments of the present invention.

### DETAILED DESCRIPTION OF ILLUSTRATIVE EMBODIMENTS

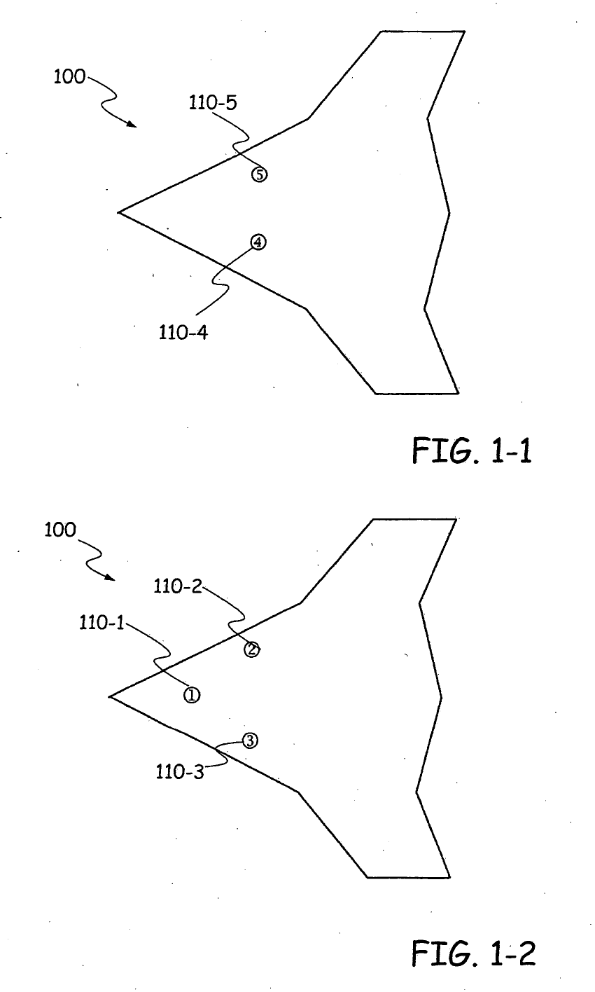

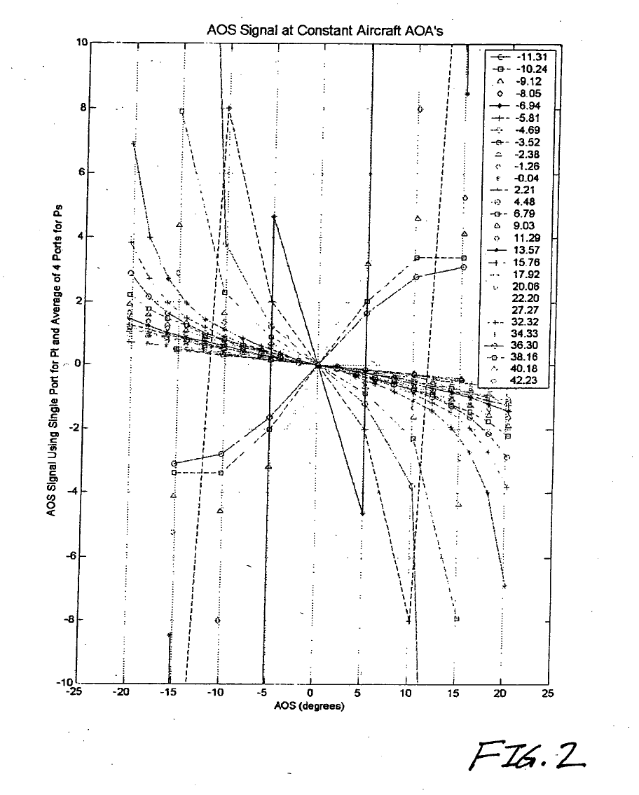

FIGS. 1-1 and 1-2 are diagrammatic illustrations, respectively in top and bottom views, of an aircraft or air vehicle 100 which employs a flush air data system (FADS) in accordance with embodiments of the present invention. Flush air data systems are generally known in the art. For example, aspects of one such FADS is described in U.S. Pat. N. 6,253,166 issued to Whitmore et al. on Jun. 26, 2001 and entitled STABLE ALGORITHM FOR ESTIMATING AIRDATA FROM FLUSH SURFACE PRESSURE MEASUREMENTS. Other examples of FADS or aspects of FADS are described in: (1) Air Data Sensing from Surface Pressure Measurements Using a Neural Network, Method AIAA Journal, vol. 36, no. 11, pp. 2094-2101(8) (1 Nov. 1998) by Rohloff T. J., Angeles L., Whitmore S. A., and Catton I; (2) Fault-Tolerant Neural Network Algorithm for Flush Air Data Sensing, Journal of Aircraft, vol. 36, iss. 3, pp. 541-549(9) (1 May 1999) by Rohloff T. J., Whitmore S. A., and Catton I; (3) Fault Tolerance and Extrapolation Stability of a Neural Network Air-Data Estimator, Journal of Aircraft, vol. 36, iss. 3, pp. 571-576(6) (1 May 1999) by Rohloff T. J. and Catton I; and (4) Failure Management Scheme for Use in a Flush Air Data System, Aircraft Design 4, pp. 151-162 (2001) by C. V. Srinatha Sastry, K. S. Raman, and B. Lakshman Babu.

The FADS employed by aircraft 100 includes, in one illustrated example, five flush (or semi-flush) static pressure sensing ports 110 positioned at various locations on the exterior of the aircraft. In these FIGS., the ports 110 are designated 110-1 through 110-5. While FIGS. 1-1 and 1-2 together illustrate five static pressure sensing ports in particular locations, the particular number and locations of ports 110 can vary as desired for the particular aircraft and application. The present invention is thus not limited to FADS having five static pressure sensing ports, or to the particular port locations shown in FIGS. 1-1 and 1-2.

The individual ports 110 each measure a single local static pressure value related to their respective locations on the aircraft. Conventionally, one of the pressure sensing ports 110 is positioned on aircraft 100 in a location which allows it to be used to measure or estimate total pressure Pₜ. For example, port 110-1 which provides a pressure measurement P₁ can represent this designated total pressure port, with P₁ serving as an estimate of total pressure Pₜ. Since this port is located in a center position, the pressure measurement it provides can also be referred to as P_{c}. Such notation is used in the Equation below. The other four ports have conventionally been used in various combinations to provide a system AOA, AOS and/or static pressure Pₛ signal (in conjunction with the Pₜ signal) which characterizes the corresponding system air data parameter(s). For example the static pressure signal Pₛ can be an average pressure \overline{Pᵢ} (for i between 2 and 5) of the pressures Pᵢ measured by ports 110-2 through 110-5. Then, the impact pressure q_{cm} can be defined as shown in Equation 1.
q_{cm}=P_{c}−\overline{Pᵢ} Equation 1

However, as noted above, as the orientation of the aircraft changes, the total pressure Pₜ measurement may be reduced to the point that it no longer remains usable as a total pressure estimate. For example, when the total pressure measurement from this port (e.g., port 110-1) becomes approximately equal to (or less than) the static pressure Pₛ measured or calculated using some or all of the other four ports (110-2 through 110-4), the impact pressure q_{cm} approaches zero or even becomes negative. As a result, the calculated air data parameters can rapidly become extremely large or even become undefined, making the air data parameter calculation unreliable or impossible.

In accordance with first embodiments of the present invention, to overcome this phenomena, instead of using a single flush static port as an indication of total pressure Pₜ, all of the available ports are considered. In an alternative embodiment, multiple but less than all of the available ports can be considered for use in providing the indication of total pressure Pₜ, so long as a single predetermined port is not solely relied upon as has conventionally been the case. In an exemplary embodiment, the maximum of the pressures P₁ through P₅ measured by ports 110-1 through 110-5 is used as the total pressure Pₜ. This ensures that the impact pressure remains a suitably large, positive value. Additionally, using this technique, the impact pressure signal is continuous for all flight conditions, i.e., there are no discontinuities in the impact pressure signal. Using this method, the impact pressure q_{cm} can be defined as shown in Equation 2.
q_{cm}=P_{MAX}−Pₛ Equation 2
where,

P_{MAX} is the maximum of the pressures measured from the flush ports 110-1 through 110-5; and

Pₛ is the system level static pressure calculated or measured by any desired method.

In various embodiments, the static pressure Pₛ used in Equation 2 can be calculated or obtained using alternate techniques. For example, this static pressure can be an average pressure \overline{Pᵢ} discussed above, but calculated using the average of all ports not having the maximum pressure P_{MAX} at any given time (i.e., all ports non currently used as the total pressure port). In one exemplary embodiment, the static pressure Pₛ used in Equation 2 is the minimum pressure P_{MIN} measured from the flush ports 110-1 through 110-5 at the particular time. With Pₛ defined in this manner, the impact pressure q_{cm} can be defined as shown in Equation 3.
q_{cm}=P_{MAX}−P_{MIN} Equation 3

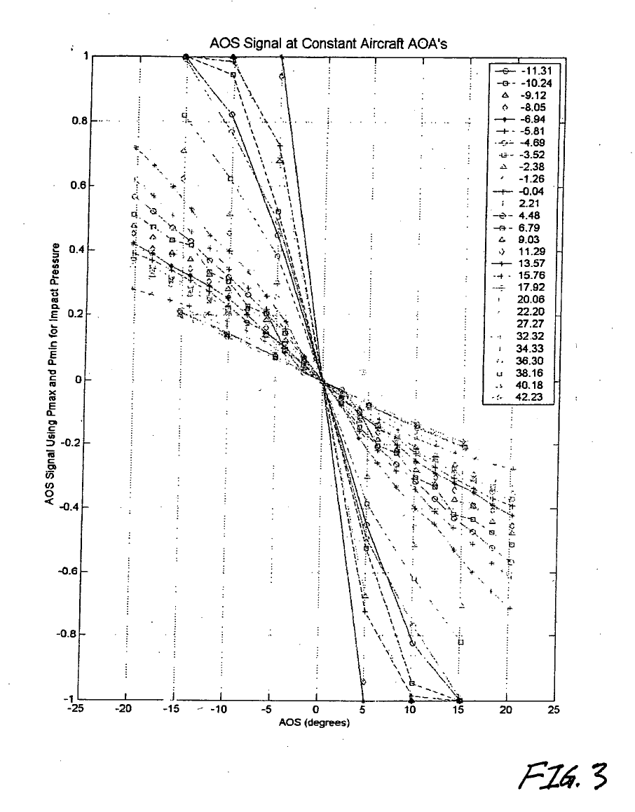

The use of these approaches compared to the traditional approach is shown in FIGS. 2 and 3. FIG. 2 is a plot showing AOS signals generated using a single port for total pressure Pₜ calculation or estimation, and an average of four ports for static pressure Pₛ calculation or estimation in the generation of q_{cm}. The AOS signal calculations in the example shown in FIG. 2 are over constant aircraft AOA's. As can be seen, the signal is very flat with AOS over some ranges, which is undesirable since a small slope does not allow for an accurate determination of true AOS. In other words, the signal is insensitive to true AOS. It can also be seen that there are sign changes in the slopes for various AOA's and locations where the AOS signal becomes undefined (becomes asymptotically steep/large) due to the extremely small calculated impact pressure q_{cm}.

Referring now to FIG. 3, shown in contrast to the plot of FIG. 2 is a plot illustrating AOS signals generated using the maximum and minimum pressure values P_{MAX} and P_{MIN} for total pressure Pₜ and static pressure Pₛ, respectively, in the generation of q_{cm}. The AOS signal calculations in the example shown in FIG. 3 are also with constant aircraft AOA's. In this case, the signal is much more monotonic over the range of AOA's and AOS's presented. In addition, the signal does not blow up as it did using the traditional approach illustrated in FIG. 2. The signals shown in FIG. 3 can therefore be used much more easily in an air data system.

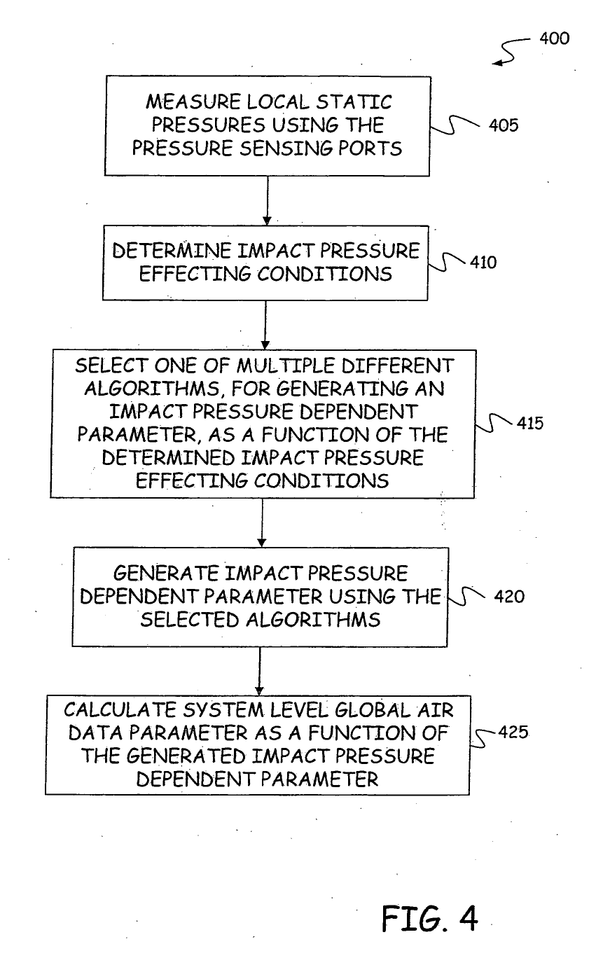

Referring now to FIG. 4, shown is a flow diagram 400 illustrating a method of calculating a system level (i.e., global or aircraft level) parameter for an aircraft using a FADS having multiple flush or semi-flush pressure sensing ports positioned on the aircraft. As illustrated at step 405 the method includes measuring local static pressures using the pressure sensing ports 110. Then, at step 410, the method includes determining impact pressure effecting conditions. For example, this step can include determining the maximum of the multiple local static pressures as described above. This can also include determining the minimum of the multiple local static pressures as described above. Other embodiments of step 410 are described later below.

After determining the impact pressure effecting conditions, the method next includes step 415 of selecting one of multiple (at least two) different algorithms (i.e., relationships and/or equations and methods of implementation) for generating an impact pressure dependent parameter. The selection of the algorithm is done as a function of the determined impact pressure effecting conditions. For example, in the embodiment described above, this step can include selecting an algorithm which uses the determined maximum of the local static pressure as the total pressure in the impact pressure calculation. To this end, selection of the algorithms from multiple different algorithms can also be the configuration of a single algorithm (e.g., Equations 2 or 3), which can be configured in multiple different ways to create different algorithms, by determining which pressure port represents the maximum pressure P_{MAX}, and using the pressure from that port in the algorithm.

Step 415 can also include selecting the algorithm which uses at least one of the remaining local static pressures to estimate a system level (global or aircraft level) static pressure P_{S} in the impact pressure calculation. For example, this can include selecting (including via configuration) an algorithm which uses the minimum of the remaining local static pressures as the system level static pressure Pₛ, such that impact pressure is calculated as a function of a difference between the determined maximum and minimum of the local static pressures. In the alternative, this can include selecting (including via configuration) an algorithm which uses some specific combination of the remaining local static pressures (e.g., a particular combination to compute \overline{Pᵢ} ) as the system level static pressure Pₛ in the impact pressure calculation. Other embodiments of step 415 are described later below.

Next, as shown at step 420, the impact pressure dependent parameter is generated using the selected algorithm(s). For example, in some embodiments, this step can include the calculation of impact pressure q_{cm} using the selected algorithm. However, in other embodiments this step can include generating an air data parameter signal (for example an AOA signal) which is dependent on impact pressure q_{cm}, for example by including it in an Equation's numerator or denominator. Such further embodiments are described below. Finally, at step 425, the method includes calculating the system air data parameter (for example, AOA, AOS, etc.) as a function of the generated impact pressure dependent parameter. This can be accomplished using known methods and techniques.

As mentioned above, in other embodiments of the present invention, the illustrated steps can be implemented using other relationships and techniques to avoid the problems associated with very small or negative impact pressures in the air data parameter calculation. For example, using a traditional algorithm, the measured pressures P₁ through P₅ can be combined to form an air data parameter signal which characterizes the system level air data parameter for the aircraft. As a more particular example of this, these pressures can be combined to form an AOA signal dP_{AOA}, which characterizes the AOA of the vehicle. Other air data parameter signals can also be calculated, such as an AOS signal. For illustrative purposes, the description of these embodiments of the present invention is primarily limited to AOA signal dP_{AOA} and AOS signal dP_{AOS}. These signals are of the form illustrated in Equations 4 and 5.

$$\begin{matrix}\frac{{dP}_{AOA}}{{q}_{cm}} = \frac{\frac{1}{2} [ ( {P}_{2} - {P}_{4} ) + ( {P}_{3} - {P}_{5} ) ]}{{q}_{cm}} & Equation 4 \\ \frac{{dP}_{AOS}}{{q}_{cm}} = \frac{\frac{1}{2} [ ( {P}_{5} - {P}_{2} ) + ( {P}_{3} - {P}_{4} ) ]}{{q}_{cm}} \\ where , & Equation 5 \\ {q}_{cm} = {P}_{1} - \frac{1}{4} ( {P}_{2} + {P}_{3} + {P}_{4} + {P}_{5} ) . & Equation 6\end{matrix}$$

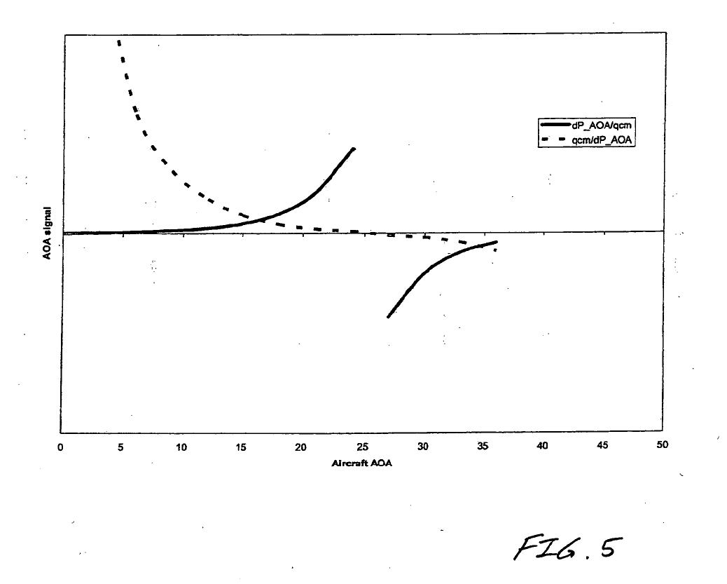

The AOA signal dP_{AOA} is usually similar to that shown in FIG. 5, which is illustrated in a manner specific to particular conditions of a particular FADS. For the case shown, dP_{AOA}/q_{cm} goes asymptotically towards ±∞ at approximately 23° AOA. This makes the signal unusable for AOA's greater than 23° because of the discontinuity. Other FADS configurations on the same or other aircraft would suffer the same problem, but perhaps at a different AOA.

In accordance with embodiments of the present invention, to overcome this problem, the inverse of the AOA signal, q_{cm}/dP_{AOA}, can be used starting at some point, instead of using the AOA signal dP_{AOA}/q_{cm} for all AOA's. For this specific example, the inverse of the AOA signal can be used beginning at AOA's of about 20° on up. Which signal to use can be determined by first looking at the value of dP_{AOA}/q_{cm}. For example, if dP_{AOA}/q_{cm} is less than a certain predetermined value, then dP_{AOA}/q_{cm} is used to determine aircraft AOA. Otherwise, q_{cm}/dP_{AOA} is used.

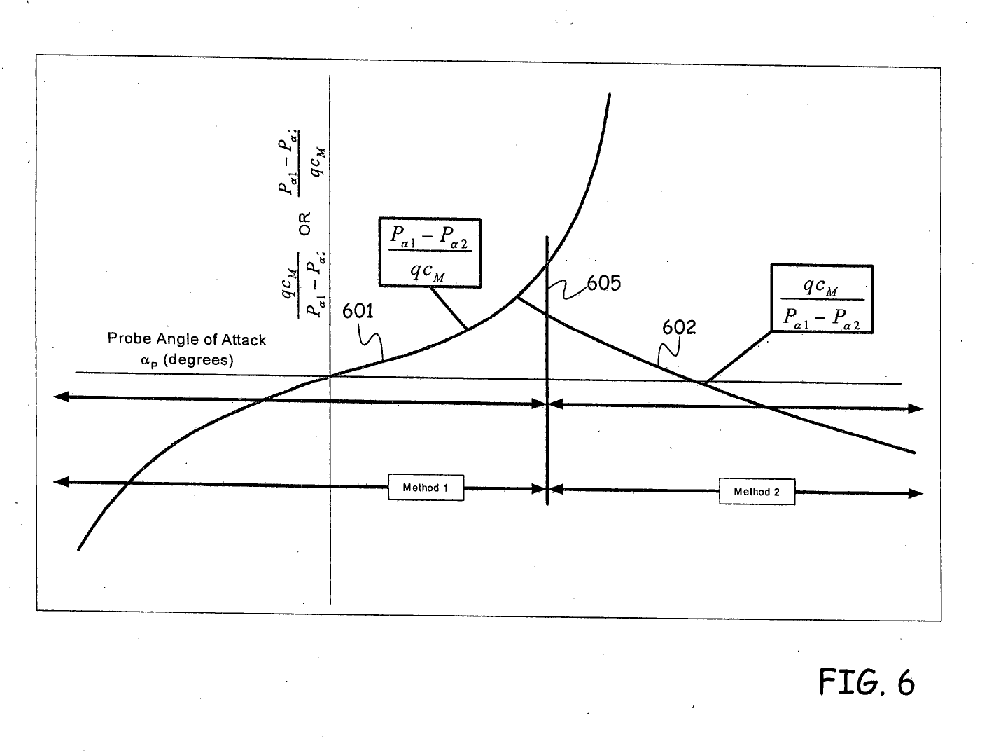

FIG. 6 is a plot illustrating the signals 601 and 602 corresponding respectively to the two alternate algorithms or methods, dP_{AOA}/q_{cm} and q_{cm/dP}_{AOA}, generically distinguishing AOA ranges over which each is used. As can be seen in FIG. 6, over AOA's below some threshold AOA (denoted by reference number 605), the first algorithm or method (dP_{AOA}/q_{cm}) is used in generating the AOA signal 601, and AOA signal 601 is used in air data parameter calculations. The threshold AOA is an AOA before the AOA signal 601 goes asymptotically towards ±∞. Over AOS's above the threshold 605, the second algorithm or method (q_{cm}/dP_{AOA}) is used in generating the AOA signal 602, and AOA signal 602 is used in air data parameter calculations.

Referring back for the moment to flow diagram 400 shown in FIG. 4, the impact pressure dependent parameter of steps 415 and 420 can be the AOA signals calculated using the algorithms dP_{AOA}/q_{cm} or q_{cm}/dP_{AOA}. The step 410 of determining impact pressure effecting conditions can therefore include determining whether the impact pressure signal calculated using a first algorithm (for example dP_{AOA}/q_{cm}) exceeds a threshold value, or determining whether an AOA indicated by the signal has surpassed a threshold AOA. The step 415 can then include selecting which of the algorithms, dP_{AOA}/q_{cm} or q_{cm}/dP_{AOA}, to use in generating the AOA signal, with the selection being based on this threshold determination. Step 420 can then include generating the AOA signal using the selected algorithm.

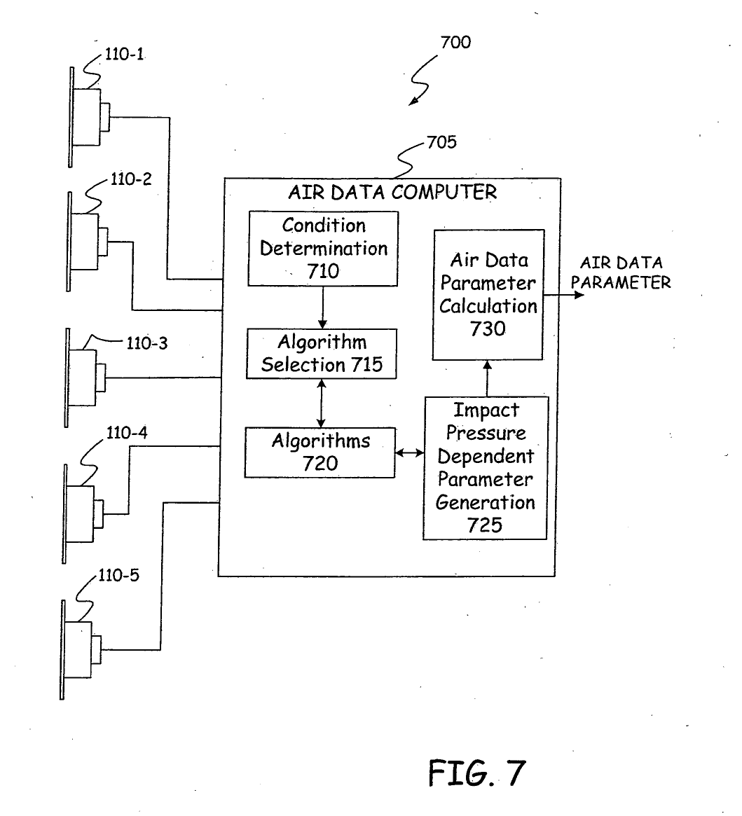

Referring now to FIG. 7 shown diagrammatically is an embodiment of FADS 700 which includes multiple flush (or semi-flush) static pressure sensing ports 110 and an air data computer 705. Ports 110 are positioned at various locations on exterior surfaces of an aircraft, for example aircraft 100 shown in FIGS. 1-1 and 1-2, in order to measure local static pressures. As was the case with the illustrative embodiment shown in FIGS. 1-1 and 1-2, in this example FADS 700 includes five flush static pressure sensing ports (110-1 through 110-5).

Air data computer 705 is coupled to the ports 110 and uses the measured local static pressures to calculate system level (i.e., aircraft level or global) air data parameters such as AOA, AOS, etc. In embodiments of the present invention, air data computer 705 is configured to do so by implementing the steps of the method illustrated in FIG. 4, for one or more of the described embodiments, in order to avoid or minimize the previously described problems of the impact pressure becoming too small or even a negative value. For illustrative purposes, air data computer 705 is therefore shown to include condition determining components or modules 710 configured to implement step 410, algorithm selection components or modules 715 for implementing step 415 by selecting (including via configuration or re-configuration of a single algorithm) an algorithm 720, impact pressure dependent parameter generation components or modules 725 for implementing step 420, and air data parameter calculation components or modules 730 for implementing step 425. The actual circuitry, including programming where appropriate, for implementing these components or modules can be in any of a wide variety of formats including suitably programmed controllers and microprocessors, neural networks, support vector machines, and other types of artificial intelligence algorithm implementing components. While these different components or modules are illustrated in air data computer 705, it must be understood that some or all of these functions can be implemented by the same suitably configured circuitry components.

Although the present invention has been described with reference to preferred embodiments, workers skilled in the art will recognize that changes may be made in form and detail without departing from the spirit and scope of the invention.

What is claimed is:

1. A method of calculating a system level air data parameter for an aircraft using a flush air data system having a plurality of flush or semi-flush pressure sensing ports positioned on the aircraft, the method comprising:
measuring a local static pressure using each of the plurality of pressure sensing ports to obtain a plurality of local static pressures;
determining impact pressure effecting conditions;
selecting one of multiple different algorithms, for generating an impact pressure dependent parameter, as a function of the determined impact pressure effecting conditions;
generating the impact pressure dependent parameter using the selected one of the multiple different algorithms; and
calculating the system level air data parameter as a function of the generated impact pressure dependent parameter.

2. The method of claim 1, wherein determining the impact pressure effecting conditions further comprises determining a maximum of the plurality of local static pressures.

3. The method of claim 2, wherein selecting the one of the multiple different algorithms further comprises selecting an algorithm which uses the determined maximum of the plurality of local static pressures as a total pressure in an impact pressure calculation.

4. The method of claim 2, wherein selecting the algorithm which uses the determined maximum of the plurality of local static pressures as the total pressure in the impact pressure calculation further comprises selecting an algorithm which uses at least one of the remaining plurality of local static pressures to estimate a system level static pressure for use in the impact pressure calculation.

5. The method of claim 4, wherein determining the impact pressure effecting conditions further comprises determining a minimum of the plurality of local static pressures.

6. The method of claim 5, wherein selecting the algorithm which uses at least one of the remaining plurality of local static pressures to estimate the system level static pressure for use in the impact pressure calculation further comprises selecting an algorithm which uses the minimum of the local static pressures as the system level aircraft static pressure in the impact pressure calculation such that the impact pressure is calculated as a function of a difference between the determined maximum and minimum of the plurality of local static pressures.

7. The method of claim 1, wherein determining the impact pressure effecting conditions further comprises determining whether the system level air data parameter has exceeded a threshold value.

8. The method of claim 7, wherein selecting the one of multiple different algorithms for generating the impact pressure dependent parameter further comprises selecting one of an air data parameter signal generating algorithm and an inverse of the air data parameter signal generating algorithm as a function of whether the system level air data parameter has exceeded the threshold value.

9. The method of claim 8, wherein the system level air data parameter is an aircraft angle of attack (AOA).

10. The method of claim 9, wherein the step of selecting one of the air data parameter signal generating algorithm and an inverse of the air data parameter signal generating algorithm comprises selecting one of an algorithm based on the relationship dP_{AOA}/q_{cm}, and an algorithm based on the relationship q_{cm}/dP_{AOA}.

11. A flush air data system (FADS) comprising:
a plurality of flush or semi-flush static pressure sensing ports positioned on an aircraft and each providing one of a plurality of measured static pressures;
an air data computer configured to implement the air data parameter calculating steps comprising:
determining impact pressure effecting conditions;
selecting one of multiple different algorithms, for generating an impact pressure dependent parameter, as a function of the determined impact pressure effecting conditions;
generating the impact pressure dependent parameter using the selected one of the multiple different algorithms; and
calculating the system level air data parameter as a function of the generated impact pressure dependent parameter.

12. The FADS of claim 11, wherein determining the impact pressure effecting conditions further comprises determining a maximum of the plurality of local static pressures.

13. The FADS of claim 12, wherein selecting the one of the multiple different algorithms further comprises selecting an algorithm which uses the determined maximum of the plurality of local static pressures as a total pressure in an impact pressure calculation.

14. The FADS of claim 13, wherein determining the impact pressure effecting conditions further comprises determining a minimum of the plurality of local static pressures.

15. The FADS of claim 14, wherein selecting the algorithm which uses the determined maximum of the plurality of local static pressures as the total pressure in the impact pressure calculation further comprises selecting an algorithm which uses the minimum of the local static pressures as a system level aircraft static pressure in the impact pressure calculation such that the impact pressure is calculated as a function of a difference between the determined maximum and minimum of the plurality of local static pressures.

16. The FADS of claim 11, wherein determining the impact pressure effecting conditions further comprises determining whether the system level air data parameter has exceeded a threshold value.

17. The FADS of claim 16, wherein selecting the one of multiple different algorithms for generating the impact pressure dependent parameter further comprises selecting one of an air data parameter signal generating algorithm and an inverse of the air data parameter signal generating algorithm as a function of whether the system level air data parameter has exceeded the threshold value.

18. The FADS of claim 17, wherein the system level air data parameter is an aircraft angle of attack (AOA).

19. The FADS of claim 18, wherein the step of selecting one of the air data parameter signal generating algorithm and an inverse of the air data parameter signal generating algorithm comprises selecting one of an algorithm based on the relationship dP_{AOA}/q_{cm}, and an algorithm based on the relationship q_{cm}/dP_{AOA}.
